(19) United States
(12) Patent Application Publication
(10) Pub. No.: US 2009/0203266 A1
(43) Pub. Date: Aug. 13, 2009

(54) HDMI CABLE ASSEMBLY WITH PROTECTION CAPABILITY

(76) Inventor: Yi-Fang CHUANG, Sanchong City (TW)

Correspondence Address: HDLS Patent & Trademark Services, P.O. BOX 220746, CHANTILLY, VA, 20153-0746, US

(21) Appl. No.: 12/342,188

(22) Filed: Dec. 23, 2008

(30) Foreign Application Priority Data
Feb. 7, 2008 (TW) 097202375

(51) Int. Cl. H01R 13/514

(52) U.S. Cl. 439/701

(57) ABSTRACT

A HDMI (High-Definition Multimedia Interface) cable assembly with protection capability includes a first connecting head, a circuit board, a cable and an outer covering body. The first connecting head is inserted into the HDMI port of a playing end or receiving end. The circuit board is electrically connected with pins of the first connecting head. The circuit board has a protective element thereon. The cable is electrically connected with the circuit board for transmitting the outputted signals of the playing end to the receiving end. The outer covering body is provided on the cable, the circuit board and the first connecting head with a portion of the first connecting head being exposed to the outside. Via this arrangement, the exposed portion of the first connecting head can be electrically connected with the HDMI port of the playing end or the receiving end. When the first and second connecting heads of the HDMI cable are inserted into or removed from the HDMI port of the playing end or the receiving end, an excessive transient current or a surge signal generated can be blocked by the protective element so as to prevent the electronic devices at the receiving end or the playing end from getting damaged.

### BACKGROUND OF THE INVENTION

1. Field of the Invention

The present invention relates to a cable, and in particular to a High-Definition Multimedia Interface (referred to as “HDMI” hereinafter) cable assembly with protection capability.

2. Description of Prior Art

HDMI is the abbreviation of “High-Definition Multimedia Interface”. The HDMI can provide a bandwidth up to 5 Gbps for data, thereby transmitting uncompressed audio signals and high-definition video signals. The HDMI allows the transmission of high-quality audio/video signals without performing any Digital/Analog conversion or Analog/Digital conversion before the transmission of signals. However, the advantage of using the HDMI lies in that: only one HDMI cable is sufficient to transmit the audio/video signals simultaneously. In comparison with the traditional transmission method of using a plurality of cables, the HDMI substantially simplifies the installation of an Audio-Video System in a house.

The traditional HDMI cable assembly has a cable. One end of the cable is electrically connected with a first connecting head, and the other end of the cable is electrically connected with a second connecting head. The exteriors of the cable, the first and second connecting heads are covered by an outer covering body. In use, the first connecting head is inserted into the HDMI port of the playing end, and the second connecting head is inserted into the HDMI port of the receiving end. When the first connecting head or the second connecting head is inserted into or removed from the HDMI port, a surge signal or an excessive reverse current may be generated easily. Alternatively, when either of the playing end or the receiving end is operated abnormally, an excessive transient current or a surge signal may be generated easily. If the excessive current or the surge signal is inputted in the playing end or the playing end reversely, the electronic device at the playing end or the receiving end may get damaged easily.

### SUMMARY OF THE INVENTION

The present invention is to provide a HDMI cable assembly with an additional protective circuit. When the first connecting head or the second connecting head of the HDMI cable is inserted into or removed from the HDMI port, or either of the playing end or the receiving end is operated abnormally, the excessive transient current or the surge signal generated can be blocked by the protective circuit, thereby preventing the electronic device at the playing end or the receiving end from getting damaged.

The present invention is to provide a HDMI cable assembly with protection capability, which includes a first connecting head, a circuit board, a cable and an outer covering body. The first connecting head is inserted into the HDMI port of the playing end or the receiving end. The circuit board is electrically connected with pins of the first connecting head. The circuit board has a protective element thereon. The cable is electrically connected with the circuit board for transmitting the outputted signals of the playing end to the receiving end. The outer covering body is provided on the cable, the circuit board and the first connecting head with a portion of the first connecting head being exposed to the outside. Via this arrangement, the exposed portion of the first connecting head can be electrically connected with the HDMI port of the playing end or the receiving end.

### BRIEF DESCRIPTION OF DRAWING

FIG. 1 is an exploded view showing the HDMI cable of the present invention;

FIG. 2 is a perspective view showing the external appearance of the HDMI cable of the present invention;

FIG. 3 is a schematic view showing the HDMI cable of the present invention and the HDMI ports of the receiving end and the playing end;

FIG. 4 is an exploded schematic view of another embodiment of the present invention; and

FIG. 5 is an assembled view showing the external appearance of another embodiment of the present invention.

### DETAILED DESCRIPTION OF THE INVENTION

The characteristics and technical contents of the present invention will be explained in detail with reference to the accompanying drawings. However, it should be noted that the drawings are illustrative only but not to limit the scope of the present invention.

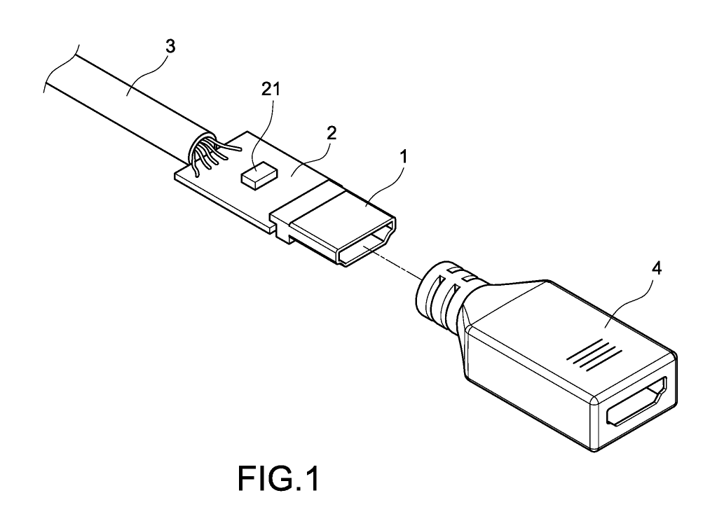

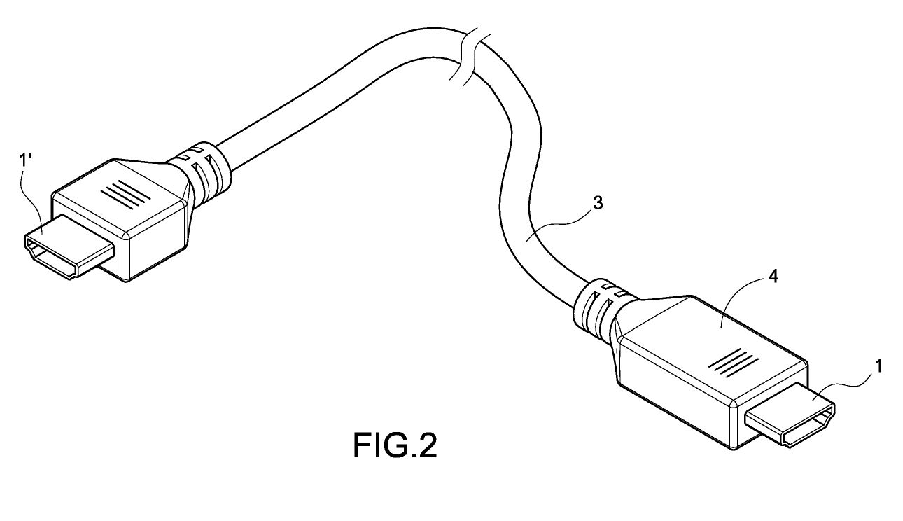

Please refer to FIGS. 1 and 2. FIG. 1 is an exploded view showing the HDMI cable of the present invention, and FIG. 2 is a perspective view showing the external appearance of the HDMI cable of the present invention. As shown in these figures, the present invention is to provide a HDMI cable assembly with protection capability, which includes a first connecting head 1, a circuit board 2, a cable 3 and an outer covering body 4.

The first connecting head 1 is inserted into the HDMI port of a playing end (not shown) or a receiving end.

The circuit board 2 is electrically connected with pins (not shown) of the first connecting head 1. A protective element 21 is provided on the circuit board 21 and is electrically connected thereto. The protective element 21 is a protective IC. When the cable 3 transmits signals, if an excessive current flows through the protective element 21, the protective element 21 can block the excessive current from entering the playing end or the receiving end to in turn cause the damage of the electronic devices at the playing end or the receiving end.

The cable 3 is electrically connected with the circuit board 2 for transmitting the outputted signals of the playing end to the receiving end.

The cable 3, the circuit board 2 and the first connecting head 1 are electrically connected to each other, and then these members are put into a mold (not shown). After plastic or rubber is injected into the mold, an outer covering body 4 can be formed on the cable 3, the circuit board 2 and the first connecting head 1. After the outer covering body 4 is manufactured completely, a portion of the first connecting head 1 is exposed to the outside, so that the exposed portion of the first connecting head 1 can be electrically connected to the HDMI port of the playing end or the receiving end.

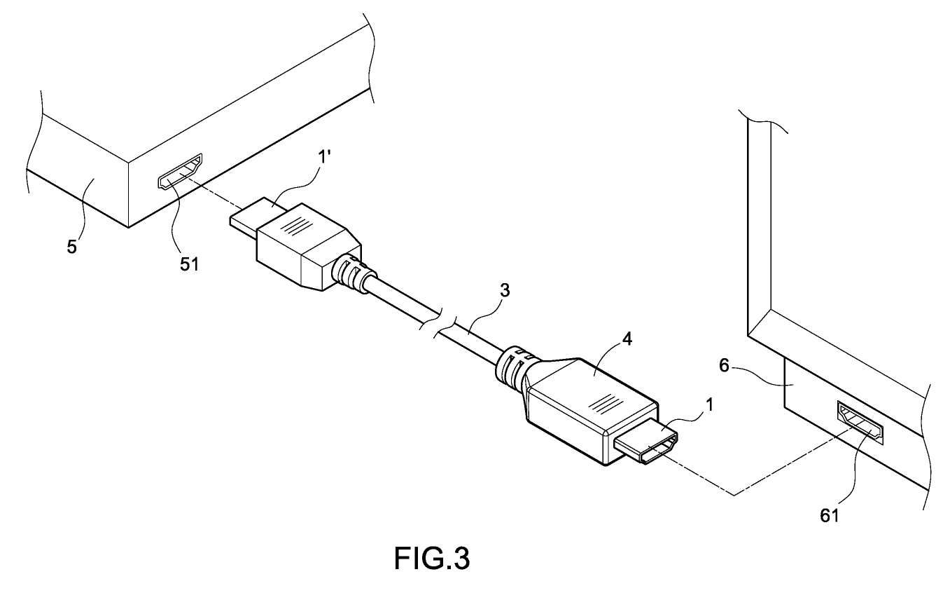

Please refer to FIG. 3, which is a schematic view showing the HDMI cable of the present invention and the HDMI ports of the receiving end and the playing end. As shown in this figure, when the first connecting head 1 of the HDMI cable is inserted into the HDMI port 51 of the receiving end 5 while the second connecting head 1′ is inserted into the HDMI port 61 of the playing end 6 to transmit the image and audio signals via the HDMI cable, if an excessive current is generated during the transmission, the protective element 21 on the circuit board 2 can block the excessive current from entering the playing end or the receiving end to in turn cause the damage of the electronic devices at the playing end or the receiving end.

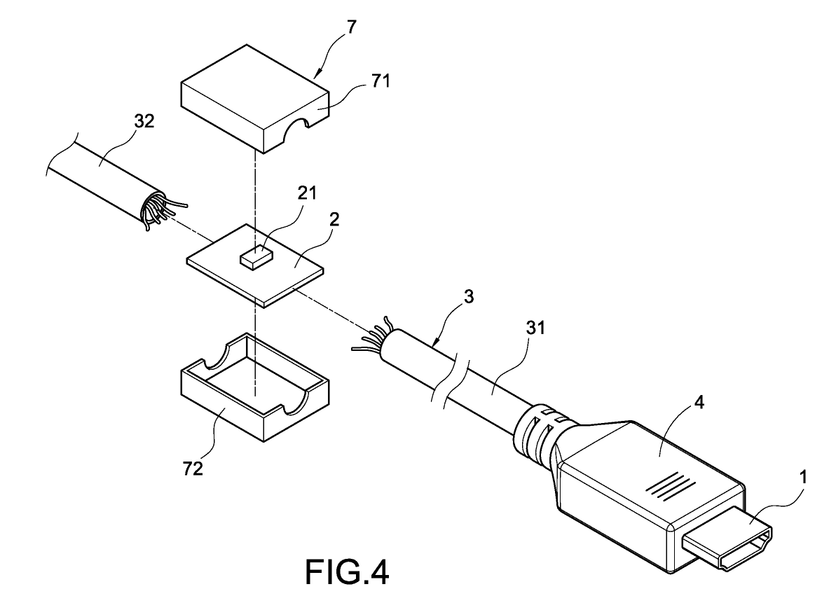

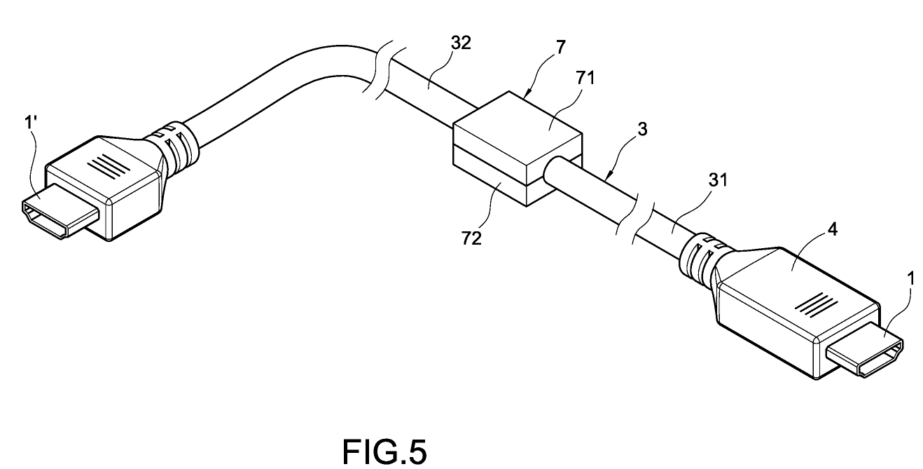

Please refer to FIGS. 4 and 5. FIG. 4 is an exploded schematic view of another embodiment of the present invention, and FIG. 5 is an assembled view showing the external appearance of another embodiment of the present invention. As shown in these figures, in the present embodiment, the circuit board 2 is electrically connected to one ends of a first cable 31 and a second cable 32 of the cable 3 respectively. The other end of the first cable 31 is electrically connected with a first connecting head 1. The first connecting head 1 and the first cable 31 are provided with an outer covering body 4. The other end of the second cable 32 is connected with a second connecting head 1′. An outer casing 7 is sealed on the circuit board 2. The outer casing 7 is constituted of an upper cover 71 and a bottom cover 72. The outer casing 7 can protect the circuit board against the collision of foreign objects.

During the transmission of the HDMI cable, if an excessive current is generated, the protective element 21 on the circuit board 2 can block the excessive current from entering the playing end or the receiving end to in turn cause the damage of the electronic devices at the playing end or the receiving end.

Although the present invention has been described with reference to the foregoing preferred embodiment, it will be understood that the invention is not limited to the details thereof Various equivalent variations and modifications can still be made in view of the teachings in the claims and specification of the present invention. Thus, all such variations and modifications are also embraced within the scope of the invention as defined in the appended claims.

What is claimed is:

1. A HDMI (High-Definition Multimedia Interface) cable assembly with protection capability, comprising:
a cable;
a first connecting head electrically connected to one end of the cable;
a circuit board electrically connected to one end of the first connecting head, a protective element being electrically connected on the circuit board; and
an outer covering body covering the cable, the first connecting head the circuit board with a portion of the first connecting head being exposed to the outside.

2. The HDMI cable assembly with protection capability according to claim 1, wherein the other end of the cable is electrically connected to a second connecting head.

3. The HDMI cable assembly with protection capability according to claim 1, wherein the protective element is a protective IC.

4. A HDMI (High-Definition Multimedia Interface) cable assembly with protection capability, comprising:
a cable having a first cable and a second cable;
a circuit board electrically connected between respective end of the first cable and the second cable, a protective element being electrically connected on the circuit board;
an outer casing assembled to the outside of the circuit board;
a first connecting head electrically connected to the other end of the first cable;
an outer covering body covering the first cable and the first connecting head with a portion of the first connecting head being exposed to the outside.

5. The HDMI cable assembly with protection capability according to claim 4, wherein the other end of the cable is electrically connected to a second connecting head.

6. The HDMI cable assembly with protection capability according to claim 4, wherein the protective element is a protective IC.

7. The HDMI cable assembly with protection capability according to claim 4, wherein the outer casing is constituted of an upper cover and a lower cover.
